(19) United States
(12) Patent Application Publication
(10) Pub. No.: US 2024/0208077 A1
(43) Pub. Date: Jun. 27, 2024

(54) GRIPPING TOOL, GRIPPING UNIT, AND HANDLING SYSTEM

(71) Applicant: Kabushiki Kaisha Toshiba, Tokyo (JP)

(72) Inventors: Taketo SHIBA, Yokohama (JP); Kazuma HIRAGURI, Yokohama (JP); Takeshi TOYOSHIMA, Yokohama (JP)

(73) Assignee: Kabushiki Kaisha Toshiba, Tokyo (JP)

(21) Appl. No.: 18/599,534

(22) Filed: Mar. 8, 2024

Related U.S. Application Data
(63) Continuation of application No. PCT/JP2023/011491, filed on Mar. 23, 2023.

(30) Foreign Application Priority Data
Mar. 23, 2022 (JP) 2022-047318

(51) Int. Cl. B25J 15/00

(52) U.S. Cl. CPC B25J 15/0028

(57) ABSTRACT

A gripping tool includes a plurality of clamping portions for clamping an object. The plurality of clamping portions extends in an extending direction. The clamping portion includes a clamping body having a clamping surface in planar to which a clamping direction for clamping the object crosses; a friction-holding elastic member disposed on the clamping surface of the clamping body; and an elastic body disposed between the friction-holding elastic member and the clamping surface, the elastic body being lower in elastic modulus than the friction-holding elastic member. The clamping portion has a deformation-restrictor extending along opposite sides of the clamping surface. The opposite sides is separate from each other in a width direction of the clamping surface. The width direction crosses the extending direction of the clamping portion. The deformation-restrictor is configured to restrict, in the width direction, deformation of the elastic body.

### TECHNICAL FIELD

Embodiments of the present invention relate to a gripping tool, a gripping unit, and a handling system.

### Background Art

Conventionally, there is known a picking robot equipped with a robot hand having a gripping unit. This type of gripping unit holds an article by clamping the article with a plurality of clamping claws. When the gripping unit is moved horizontally with the article clamped by the clamping claws, a moment due to inertial force acts on the gripping unit.

### CITATION LIST

### Patent Document

### Patent Document 1

Japanese Patent No. 6883908

### SUMMARY OF INVENTION

### Technical Problem

An object of the present invention is to provide a gripping tool, a gripping unit, and a handling system capable of reliably and stably clamping objects of various shapes.

### Solution to Problem

A gripping tool of an embodiment includes a plurality of clamping portions which are provided to be able to clamp an object and extend in one direction. The clamping portion includes a clamping body which has a planar clamping surface from which a clamping direction for clamping the object is vertical, a friction-holding elastic member which is disposed on the clamping surface side of the clamping body, and an elastic body which is disposed between the friction-holding elastic member and the clamping surface and has a lower elastic modulus than the friction-holding elastic member. The clamping surface is provided with a deformation-restrictor which is provided on both sides of the clamping surface in a width direction intersecting the extending direction of the clamping portion and restricts the deformation of the elastic body in the width direction.

### BRIEF DESCRIPTION OF DRAWINGS

FIG. 1 is a schematic view of a picking robot of an embodiment.

FIG. 2 is a side view of a robot hand of the embodiment.

FIG. 3 is a front view of the robot hand of the embodiment.

FIG. 4 is a perspective view of a main part of a gripping unit.

FIG. 5 is a perspective view of a main part of the gripping unit.

FIG. 6 is a side view of a clamping claw.

FIG. 7 is an exploded perspective view of the clamping claw.

FIG. 8 is a longitudinal sectional view of the clamping claw.

FIG. 9 is a front view of the clamping claw.

FIG. 10A is a perspective view of a clamping body of the clamping claw.

FIG. 10B is a perspective view when an elastic body of the clamping claw is disposed.

FIG. 10C is a perspective view when a friction-holding rubber member of the clamping claw is disposed.

### DESCRIPTION OF EMBODIMENTS

Hereinafter, a gripping tool, a gripping unit, and a handling system of an embodiment will be described with reference to the drawings.

An XYZ Cartesian coordinate system is used to describe the gripping tool, gripping unit, and handling system of the embodiment. The Z-axis direction corresponds to the vertical direction, the +Z direction is defined as upward, and the −Z direction is defined as downward. The X-axis direction and the Y-axis direction are orthogonal to each other in the horizontal plane. In the horizontal plane, the gripping direction in which a clamping claw 40 of a gripping unit 21 (described later) opens and closes is defined as the X-axis direction. In the horizontal plane, the direction perpendicular to the clamping direction in which the clamping claw 40 opens and closes is defined as the Y-axis direction. Further, in the following description, the X-axis direction may be referred to as the clamping direction, the Y direction may be referred to as the width direction, and the Z direction may be referred to as the extending direction, as necessary.

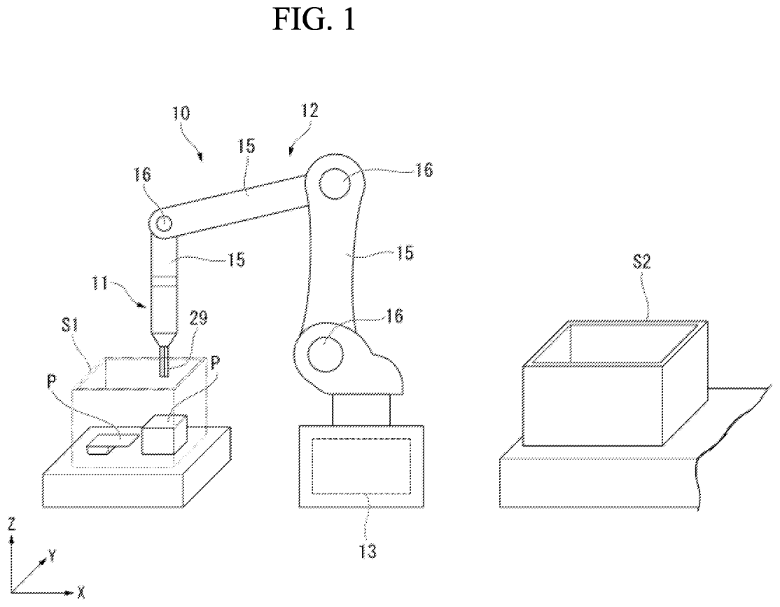

FIG. 1 is a schematic view showing a schematic configuration of a picking robot 10 of the embodiment.

As shown in FIG. 1, the picking robot 10 (handling system) includes a robot hand 11, an arm 12, and a control unit 13. The robot hand 11 holds an object P to be transported. The arm 12 moves the robot hand 11 to a predetermined location. The control unit 13 controls each part of the robot hand 11 and the arm 12. The configuration of the robot hand 11 will be described in detail later.

Hereinafter, the outline of the configuration and operation of the picking robot 10 will be described.

The picking robot 10 is used, for example, as a picking robot for logistics. The picking robot 10 holds various objects P placed in various situations at a transport source S1 and moves them to a transport destination S2. Furthermore, the use of the picking robot 10 is not limited to logistics, but can be widely applied to industrial and other uses. For example, the picking robot 10 of this embodiment is not limited to a device of which a main purpose is to transport the object P, but also includes devices that transport or move articles as part of other purposes, such as assembly of products.

The transport source S1 is, for example, various conveyors, pallets, containers, etc., but is not limited to these. At the transport source S1, multiple types of objects P having different dimensions and weights are placed at random positions in an arbitrary posture. The dimension of the object P to be transported varies, for example, from about several cm square to about several tens of cm square. The weight of the object P varies, for example, from about several tens of grams to several kilograms. Furthermore, the dimensions and weight of the object P are not limited to the above example.

Like the transport source S1, the transport destination S2 is, for example, various conveyors, pallets, containers, and the like, but is not limited to these. Furthermore, the containers of the transport source S1 and the transport destination S2 broadly refer to members capable of accommodating the object P, for example, box-shaped members.

The arm 12 is composed of, for example, a 6-axis vertical multi-joint arm. The arm 12 includes a plurality of arm members 15 and a plurality of joint portions 16. The joint portion 16 rotatably connects the arm members 15 connected to the joint portion 16. Furthermore, the arm 12 may be composed of, for example, a 4-axis vertical multi-joint arm or a 3-axis orthogonal arm. The arm 12 may be a mechanism for moving the robot hand 11 to a desired position using a configuration other than a vertical multi-joint arm or an orthogonal arm. Although not shown in the drawings, the arm 12 includes a sensor, and the like that detects the angle formed by the arm member 15 at each joint portion 16.

Although not shown in the drawings, the picking robot 10 further includes a sensor installed in the vicinity of the transport source S1 and the transport destination S2. The sensor includes, for example, an RGB-D sensor, a camera, a contact sensor, a distance sensor, and the like. The sensor acquires, for example, information regarding the object P placed at the transport source S1, information regarding the status of the transport source S1 or the transport destination S2, and the like.

The control unit 13 manages and controls each part of the picking robot 10. The control unit 13 acquires various information detected by the sensor, and controls the position and operation of the robot hand 11 on the basis of the acquired information. The control unit 13 is composed of a microcomputer equipped with a processor such as a Central Processing Unit (CPU). The control unit 13 is realized by a processor such as a CPU executing a program stored in a memory or an auxiliary storage device. At least a part of the control unit 13 may be realized by hardware such as Large Scale Integration (LSI), Application Specific Integrated Circuit (ASIC), Field-Programmable Gate Array (FPGA), or by combination of software and hardware.

Hereinafter, the robot hand 11 will be described.

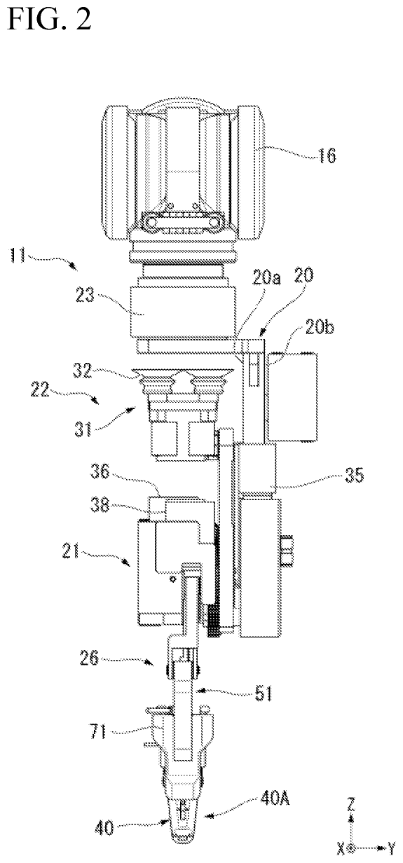

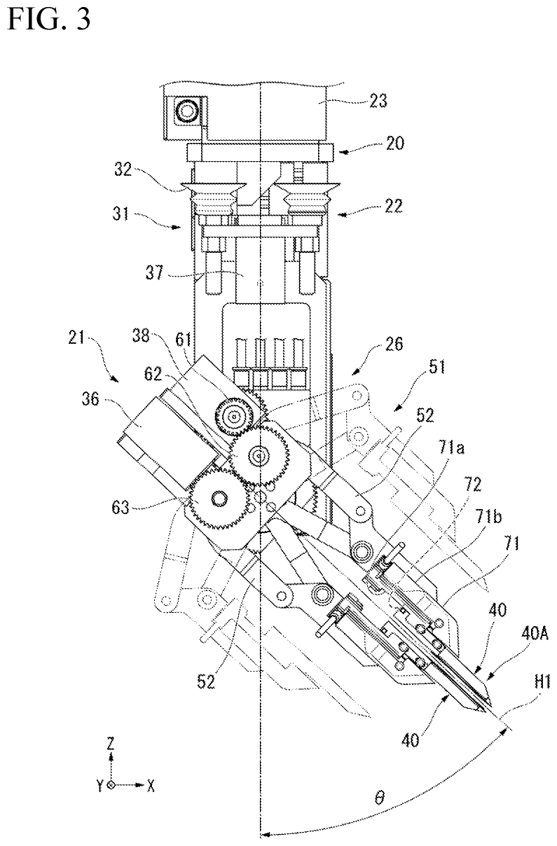

FIG. 2 is a side view of the robot hand 11 when viewed from the +X direction. FIG. 3 is a front view of the robot hand 11 when viewed from the −Y direction. In this specification, a view of each device viewed from the +X direction is referred to as a side view, and a view of each device viewed from the −Y direction is referred to as a front view.

As shown in FIG. 2, the robot hand 11 includes a base plate 20, a gripping unit 21, a suction unit 22, and a force sensor 23.

The base plate 20 is a plate-shaped member and includes a first surface 20a and a second surface 20b which face each other. The base plate 20 supports the gripping unit 21 and the suction unit 22. The gripping unit 21 and the suction unit 22 face the first surface 20a of the base plate 20. The gripping unit 21 and the suction unit 22 are arranged side by side in the Y-axis direction. The base plate 20 is disposed only on one side of the gripping unit 21 and the suction unit 22, and is not disposed on the other side. That is, the gripping unit 21 and the suction unit 22 are not clamped by the base plate 20 from both sides, but are supported in a cantilevered manner with respect to the base plate 20.

The suction unit 22 is disposed to face the first surface 20a of the base plate 20. The gripping unit 21 is disposed on the side opposite to the side where the base plate 20 is located with respect to the suction unit 22. That is, these two units 21 and 22 are arranged in the order of the suction unit 22 and the gripping unit 21 from the first surface 20a of the base plate 20. A part of the base plate 20, a part of the suction unit 22, and a part of the gripping unit 21 are arranged at positions overlapping each other when viewed from the normal direction (Y-axis direction) of the first surface 20a.

The suction unit 22 includes a plurality of suction pads 32.

The suction unit 22 uses the plurality of suction pads 32 to hold the object P in a negative pressure suction manner. The suction unit 22 is rotatably supported by the base plate 20 in a plane parallel to the first surface 20a (in the XZ plane).

As shown in FIGS. 2 and 3, the gripping unit 21 includes a gripping tool 40A having a plurality of clamping claws 40 (clamping portions). The gripping unit 21 uses the plurality of clamping claws 40 to grip and hold the object P from the sides (X-axis direction). The gripping unit 21 is supported by the base plate 20 to be rotatable in a plane parallel to the first surface 20a (in the XZ plane).

The force sensor 23 is disposed on the upper portion of the base plate 20. The force sensor 23 detects a load applied to the clamping claw 40 when the clamping claw 40 comes into contact with any object such as the floor, wall, other obstacles, object P. The detected value of the force sensor 23 is output to the control unit 13 and used to control various operations of the gripping unit 21.

The robot hand 11 has a switching function, a posture changing function, and an opening/closing function. The switching function is a function of switching which of the gripping unit 21 and the suction unit 22 to use for holding the object P depending on the object P. The posture changing function has a function of changing the posture of the gripping unit 21 and a function of changing the posture of a suction portion 31 including the plurality of suction pads 32. The opening/closing function is a function of opening and closing the clamping claws 40. In order to realize these functions, the robot hand 11 includes a first motor 35, a second motor 36, a third motor 37, and a fourth motor 38.

The rotation of the first motor 35 is transmitted to the gripping unit 21 via a rotation transmission mechanism (not shown). The gripping unit 21 is rotated by the first motor 35. As shown in FIG. 3, the posture in which the holding center line H1 faces vertically downward is defined as 0°. The gripping unit 21 can change its posture so that the holding center line H1 faces counterclockwise, for example, at an angle −θ. Contrary to FIG. 3, the gripping unit 21 can also change its posture so that the holding center line H1 faces clockwise at an angle +θ. In this way, the plurality of clamping claw 40 can change the posture. Furthermore, the holding center line H1 is defined as a straight line parallel to the Z axis at the initial position of the gripping unit 21 (the position before changing the posture) and a straight line passing through the center of two clamping claws 40 in the opening/closing direction (X-axis direction) and the center of one clamping claw 40 in the width direction (Y-axis direction).

When switching the units 21 and 22, the gripping unit 21 and the suction unit 22 are rotated together by the driving force of the first motor 35. When changing the posture of the gripping unit 21, the second motor 36 rotates together with the rotation of the first motor 35. The suction unit 22 is rotated by the driving force of the second motor 36 in a direction that offsets the change in the posture of the suction unit 22 due to the change in the posture of the gripping unit 21. Accordingly, as shown in FIG. 3, even if the posture of the gripping unit 21 changes, the posture of the suction unit 22 does not change while facing upward in the vertical direction.

The driving force of the third motor 37 is transmitted to the suction portion 31 including the plurality of suction pads 32 via the rotation transmission mechanism (not shown). Accordingly, the posture of the suction portion 31 changes in accordance with the rotation of the third motor 37.

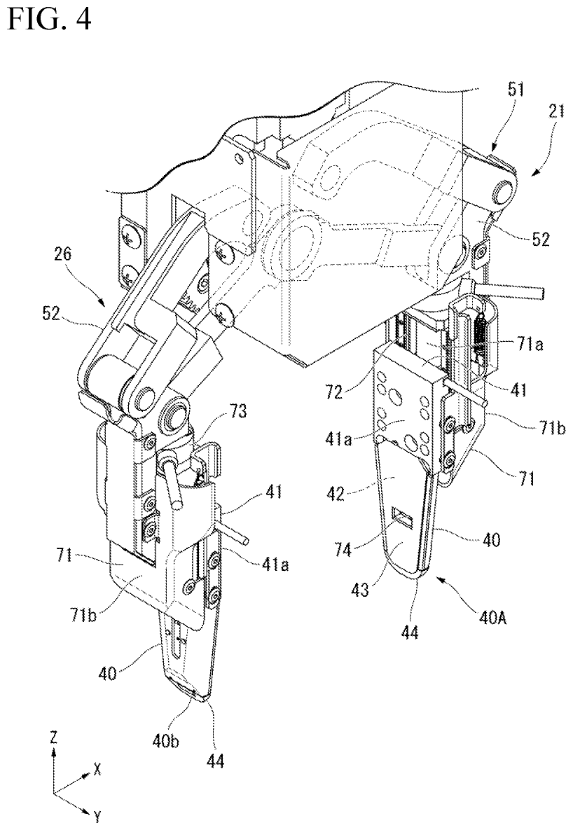

As shown in FIG. 3, the gripping unit 21 includes the plurality of (in this embodiment, two) clamping claws 40, a clamping claw opening-closing portion 26 (clamping portion opening-closing portion), a base member 71, and a linear guide 72 (see FIG. 4). The clamping claw opening-closing portion 26 includes a link portion 51, a first gear 61, a second gear 62, and a third gear 63.

The gripping unit 21 of this embodiment includes two clamping claws 40 connected to the link portion 51. Furthermore, the number of clamping claws 40 may be three or more and is not particularly limited.

The link portion 51 is composed of two parallel links 52. Two clamping claws 40 are respectively connected to two parallel links 52. Due to the movement of the link portion 51, two clamping claws 40 are opened and closed by moving in a direction in which a gap therebetween increases while moving upward in the height direction of the gripping unit 21 and by moving in a direction in which the gap therebetween decreases while moving downward in the height direction of the gripping unit 21.

The first gear 61 is connected to the fourth motor 38. The second gear 62 engages with the first gear 61. The third gear 63 engages with the second gear 62. When the first gear 61 is rotated by the driving of the fourth motor 38, the second gear 62 and the third gear 63 rotate in the opposite directions within the XZ plane and two parallel links 52 move. Two clamping claws 40 perform either an opening operation or a closing operation depending on which direction the second gear 62 and the third gear 63 rotate.

FIG. 4 is a perspective view showing a main part of the gripping unit 21. As shown in FIGS. 2 and 4, the base member 71 is composed of a plate-shaped member. The base member 71 includes a first surface 71a which faces the inside of the clamping direction X and a second surface 71b which faces the side opposite to the first surface 71a. The upper end of the base member 71 is connected to the parallel link 52. The first surface 71a of the base member 71 is provided with the linear guide 72 that extends in the longitudinal direction (Z-axis direction) of the base member 71.

The linear guides 72 are provided as a pair in the width direction Y on the first surface 71a of the base member 71. The clamping claws 40 are supported by the linear guide 72 to be movable in parallel. That is, the clamping claws 40 are guided by the pair of left and right linear guides 72 provided on the first surface 71a of the base member 71, and are movable along the length direction (Z-axis direction) of the linear guides 72.

Hereinafter, the configuration of the pair of clamping claws 40 provided in the gripping tool 40A will be described.

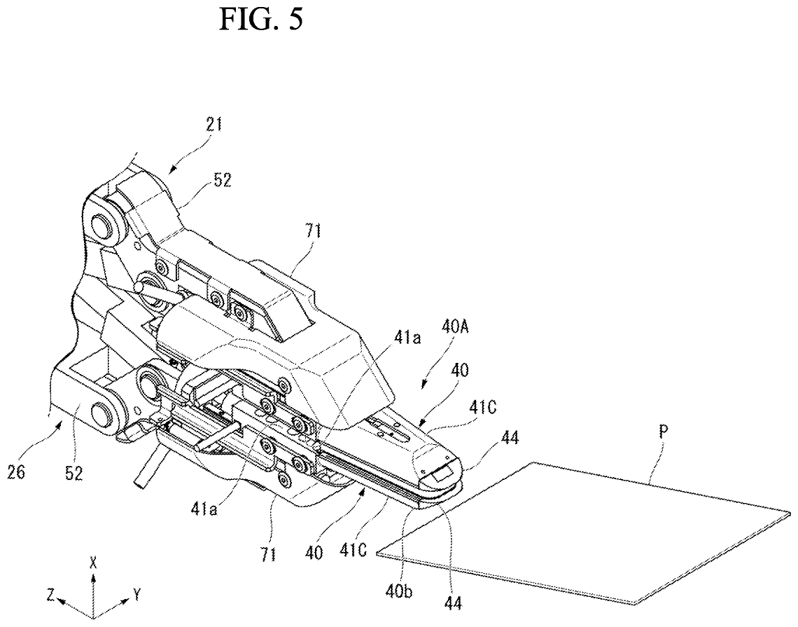

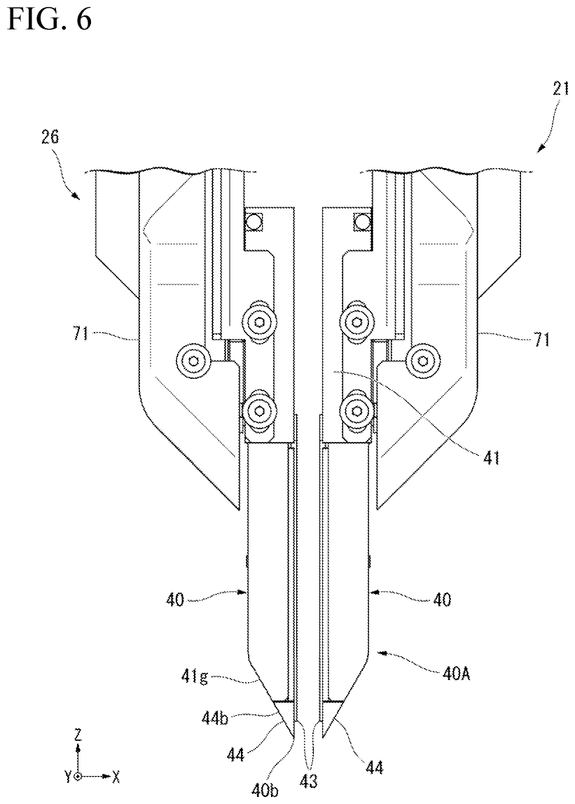

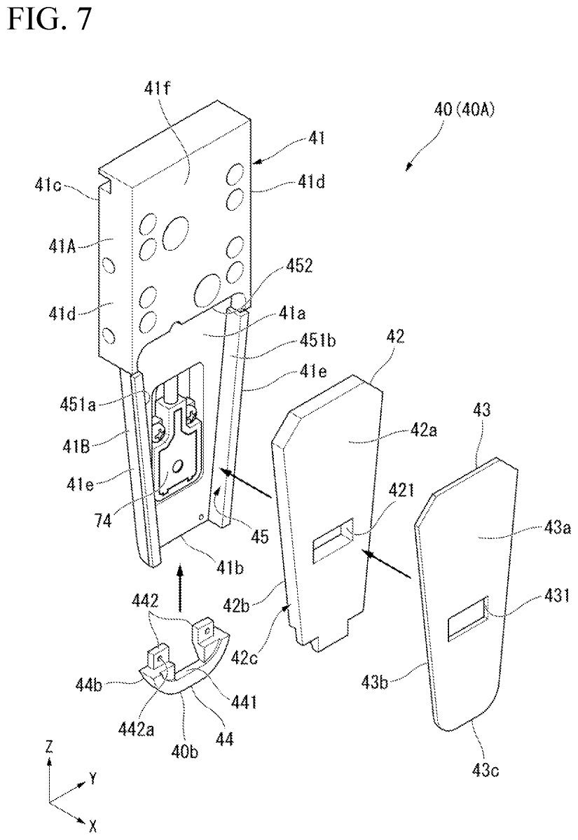

FIG. 5 is a perspective view before the sheet-shaped thin plate member (object P) is clamped by the clamping claws 40. FIG. 6 is a side view of the clamping claw 40. FIG. 7 is an exploded perspective view of the clamping claw 40.

As shown in FIGS. 4 to 7, two clamping claws 40 have the same configuration. Two clamping claws 40 are arranged in a direction in which clamping surfaces 41a described below face each other.

As shown in FIG. 5, the clamping claw 40 includes a claw body 41 (clamping body) which is made of a rigid body (for example, stainless steel such as SUS303) having the flat clamping surface 41a intersecting the clamping direction X that clamps the object P, an elastic body 42 which is disposed on the clamping surface 41a of the claw body 41, a friction-holding rubber member 43 (friction-holding elastic member) that is laminated on the opposite surface in the clamping direction X to the clamping surface 41a of the elastic body 42, and a tip elastic member 44 which is provided at a tip 40b and has a higher elastic modulus than the elastic body 42. The clamping surface 41a is disposed on the inner side of the claw body 41 in the clamping direction X (the side where the object P is located). As an example of the shape of the clamping claw 40, for example, a shape is preferable in which the length in the extending direction Z is 100 mm, the minimum width of the tip in the width direction Y is 20 mm or less, the minimum thickness of the tip 40b in the claw thickness direction is 8 mm or less, and each side in the width direction and the thickness direction is tapered.

Here, in the clamping claw 40, as described above, the longitudinal direction of the claw body 41 is defined as the extending direction Z, the direction intersecting the extending direction Z within the plane of the clamping surface 41a is defined as the width direction Y, and the direction orthogonal to the plane direction of the clamping surface 41a is defined as the thickness direction (clamping direction X). In this embodiment, the clamping surface 41a is within the YZ plane, and its width is orthogonal to the Z-axis direction.

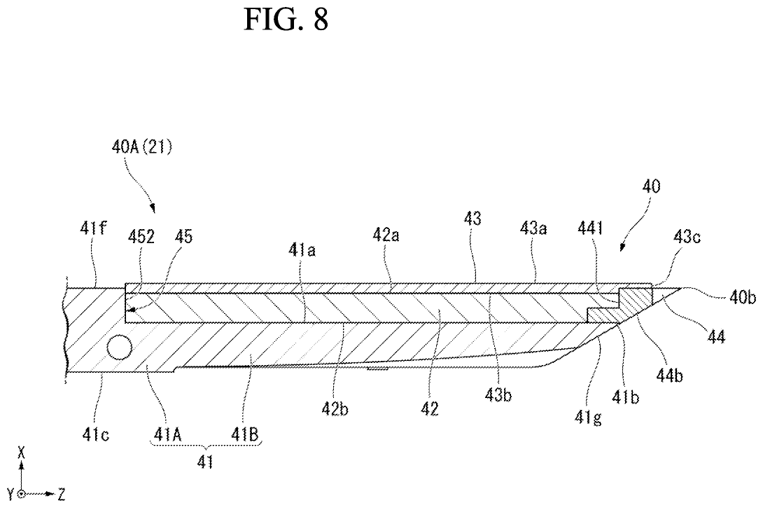

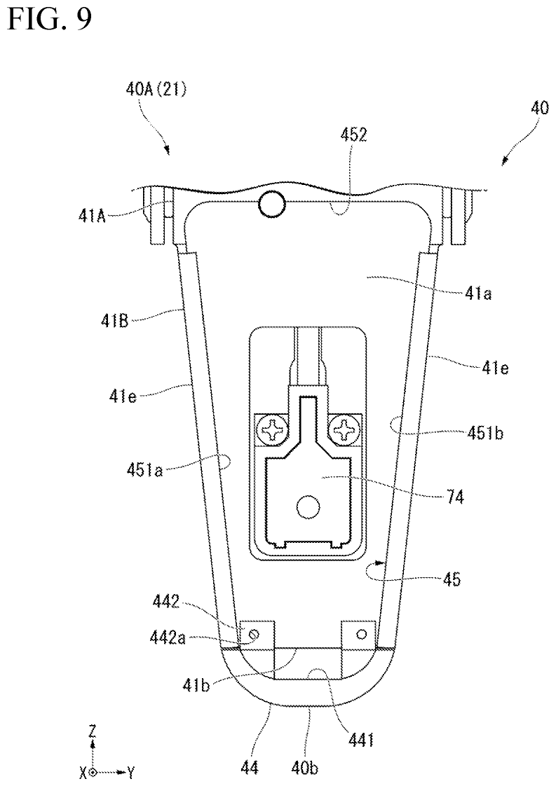

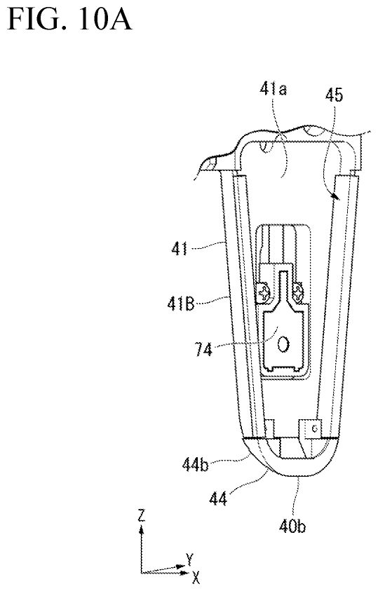

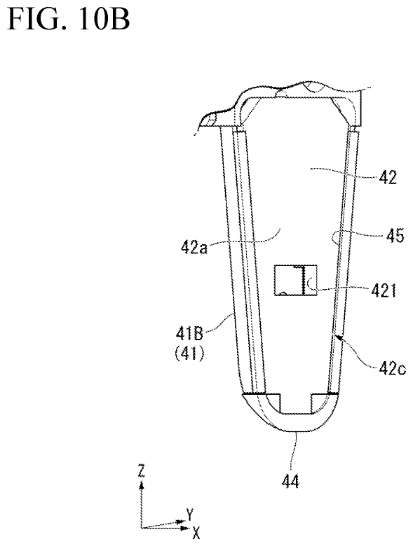

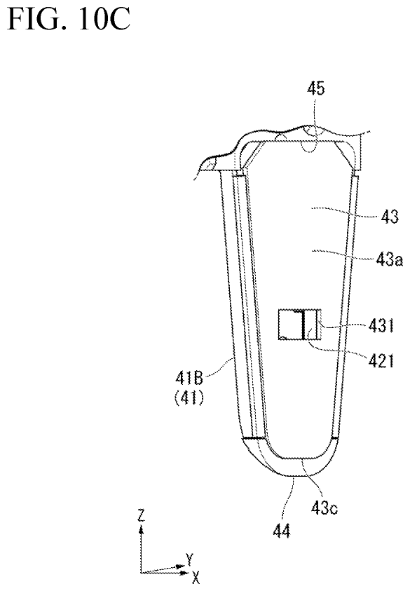

FIG. 8 is a longitudinal sectional view of the clamping claw 40. FIG. 9 is a front view of the clamping claw 40. FIG. 10A is a perspective view of the claw body 41 of the clamping claw 40. FIG. 10B is a perspective view when the elastic body 42 is disposed on a recessed portion 45 of the claw body 41. FIG. 10C is a perspective view when the friction-holding rubber member is disposed on the surface of the elastic body 42. As shown in FIGS. 7, 8, and 9 and FIGS. 10A to 10C, the claw body 41 includes a base end 41A and a clamping portion 41B. The base end 41A is attached to the linear guide 72 of the gripping unit 21. The clamping portion 41B is connected to the tip side of the base end 41A in the extending direction Z and has the clamping surface 41a. The clamping portion 41B is provided with a cover member 41C (see FIG. 5) which covers the outer peripheral side of the clamping portion 41B. Further, the claw body 41 includes a displacement sensor 73 (see FIG. 4) and a transmission type presence sensor 74.

As shown in FIG. 7, in the base end 41A, both side surfaces 41d facing in the width direction Y and extending in the extending direction Z are parallel to each other. An outer surface 41c of the base end 41A on the outside in the clamping direction X is connected to the base member 71 through the linear guide 72. As shown in FIG. 4, the claw body 41 can be displaced in the extending direction Z by moving in parallel along the linear guide 72. In other words, the clamping claw 40 can be expanded and contracted with respect to the base member 71 by moving the claw body 41 in parallel along the linear guide 72.

The clamping portion 41B clamps the object P while bringing the clamping surface 41a into contact with the object P. The clamping portion 41B has a tapered shape when viewed from the clamping direction X while a pair of side surfaces 41e facing each other in the width direction Y form a tapered surface inclined inward in the width direction Y as it goes toward the tip in the extending direction Z. The width of the tip 40b of the clamping portion 41B is less than, for example, 20 mm. Further, the thickness of the clamping portion 41B in the clamping direction X decreases as it goes toward the tip 40b. The clamping portion 41B has a tapered shape when viewed from the width direction Y.

The clamping surface 41a of the clamping portion 41B is provided with the recessed portion 45 (deformation-restrictor) which restricts the deformation of the elastic body 42 in the width direction Y. The recessed portion 45 has a substantially trapezoidal shape when viewed from the front side in the clamping direction X (see FIG. 8). The recessed portion 45 includes a pair of first inner wall surfaces 451a and 451b, a second inner wall surface 452, and a third inner wall surface 441. The pair of first inner wall surfaces 451a and 451b are provided on both sides of the width direction Y orthogonal to the extending direction Z. The second inner wall surface 452 connects one base ends of the pair of first inner wall surfaces 451a and 451b in the extending direction Z in the width direction Y. The third inner wall surface 441 is provided in the tip elastic member 44 and connects the other base ends of the pair of first inner wall surfaces 451a and 451b in the extending direction Z.

The recessed portion 45 forms the clamping surface 41a on the inner side over the entire circumference which is surrounded by the inner wall surfaces 451a, 451b, 452, and 441 forming four sides. In this embodiment, the first inner wall surfaces 451a and 451b are provided separately from the claw body 41, but may be provided integrally with the claw body 41.

As shown in FIGS. 7, 8, and 10B, a foamable material (porous elastic member) having a certain degree of flexibility and said to be a material with a low elastic modulus is used as the material of the elastic body 42. Examples of the elastic body 42 include ethylene propylene diene rubber (EPDM), neoprene type, EPT type, nitrile (NBR) type, natural rubber (NR) type, styrene butadiene rubber (SBR) type, urethane type, etc and a thin plate-shaped sponge rubber having a thickness of about 3 mm can be used. The thickness of the elastic body 42 is larger than the thickness of the friction-holding rubber member 43. For example, in the case of the elastic body 42 having a thickness of 3 mm, the elastic body is elastically deformed with a dent of just under 3 mm when the elastic body is pressed in the thickness direction (that is, the clamping direction X) at the time of clamping the object P, and the elastic body elastically returns to its original thickness when the pressure is stopped.

The planar shape of the elastic body 42 when viewed from the clamping direction X is substantially the same as the planar shape of the recessed portion 45. The elastic body 42 is bonded with the first surface 42a facing inward in the clamping direction X and the second surface 42b facing the clamping surface 41a in the recessed portion 45.

As shown in FIGS. 7 and 8, the elastic body 42 is fitted into the recessed portion 45. The second surface 42b of the elastic body 42 is bonded with an adhesive or the like in surface contact with the clamping surface 41a, which is the bottom surface of the recessed portion 45. Accordingly, the elastic body 42 is held by the pair of first inner wall surfaces 451a and 451b, the second inner wall surface 452, and the third inner wall surface 441. The elastic body 42 fitted into the recessed portion 45 is provided so that the first surface 42a does not protrude outside the recessed portion 45. That is, the first surface 42a of the elastic body 42 is located inside the position of the inner surface 41f of the claw body 41. The center of the elastic body 42 is provided with an opening portion 421 that penetrates in the thickness direction.

As shown in FIGS. 7, 8, and 10C, for example, a material that can be embossed on the surface (first surface 43a) and has a higher elastic modulus than the member of the elastic body 42 is used as the material of the friction-holding rubber member 43. Examples of the friction-holding rubber member 43 include natural rubber (NR), styrene-butadiene rubber(SBR), butadiene rubber (BR), butyl rubber (IIR), etc and for example, a sheet-shaped high-friction rubber with a thickness of about 1 mm will be adopted. It is preferable that the friction-holding rubber member 43 has a characteristic that the friction-holding rubber member can be bent to follow the elastic deformation of the elastic body 42. Here, as the friction-holding rubber member 43, it is possible to use an applicable elastic body other than the above-described rubber member.

The planar shape of the friction-holding rubber member 43 when viewed from the clamping direction X is substantially the same as the planar shape of the recessed portion 45 and the elastic body 42. The friction-holding rubber member 43 is laminated on the first surface 42a of the elastic body 42, and is bonded to the first surface 42a with an adhesive or the like in surface contact. The tip side end of the friction-holding rubber member 43 extends longer toward the tip side than the tip side end of the elastic body 42. As shown in FIG. 8, the friction-holding rubber member 43 is laminated on the elastic body 42 so that a part on the side of the second surface 43b is located in the recessed portion 45 and the first surface 43a protrudes inward in the clamping direction X from the inner surface of the base end 41A of the claw body 41. The center of the friction-holding rubber member 43 is provided with an opening portion 431 that penetrates in the thickness direction.

As shown in FIG. 7, the tip elastic member 44 is provided at the tip 41b of the claw body 41 and is made of a member having a higher elastic modulus than the elastic body 42. Specifically, the tip elastic member 44 is made of, for example, a material such as nitrile rubber (NBR) or resin having a hardness of about 70.

As shown in FIG. 7, the tip elastic member 44 is fixed to the tip of the clamping portion 41B of the claw body 41 with a screw or the like. The tip elastic member 44 includes a tip tapered surface 44b which decreases in thickness toward the tip on the outer surface opposite to the clamping surface 41a in the clamping direction X when viewed from the width direction Y. The tip tapered surface 44b is closely adjacent to and aligned with a body-tapered surface 41g of the clamping portion 41B shown in FIG. 8. Further, the width dimension of the tip elastic member 44 in the width direction Y when viewed from the clamping direction X becomes thinner toward the tip side. That is, the tip elastic member 44 has a tapered shape in both width and thickness.

The third inner wall surface 441 that forms the tip side inner wall surface of the recessed portion 45 is provided on the inner surface of the tip elastic member 44 on the inside of the clamping direction X.

The tip elastic member 44 is provided with a fixing protrusion 442 which is fixed to the tip 41b of the clamping portion 41B of the claw body 41 by a screw or the like. The fixing protrusion 442 has a screw hole 442a.

As shown in FIG. 4, the transmission type presence sensor 74 is embedded in the clamping surface 41a of the claw body 41. The presence sensor 74 provided in one clamping claw 40 faces the presence sensor 74 provided in the other clamping claw 40 through the opening portions 421 and 431 provided in the elastic body 42 and the friction-holding rubber member 43. The opening portions 421 and 431 are openings for transmitting the detection laser beam of the transmission type presence sensor 74. The presence sensor 74 detects the presence or absence of an object located between two clamping claws 40 by detecting transmission or blocking of light such as visible light or infrared light.

As shown in FIG. 4, the displacement sensor 73 is disposed above the base member 71. The displacement sensor 73 detects the displacement amount of the clamping claw 40 when the clamping claw 40 comes into contact with an arbitrary object so that the clamping claw 40 is displaced. As a structure in which the displacement sensor 73 detects the displacement amount of the clamping claw 40, the displacement sensor 73 detects the displacement amount of the clamping claw 40 in accordance with a distance change amount since the distance between the clamping claw 40 and the displacement sensor 73 changes when the clamping claw 40 comes into contact with an object to escape (displace). The detected value of the displacement sensor 73 is output to the control unit 13 and is used to control the operation of the clamping claw 40. As the displacement sensor 73, various displacement sensors are used, such as a laser displacement sensor, a magnetic displacement sensor, and a capacitive displacement sensor.

The control unit 13 shown in FIG. 1 receives a detection signal from the displacement sensor 73 and determines whether to control the operation of the clamping claw 40 on the basis of the detection value of the displacement sensor 73.

Hereinafter, the operation and effect of the gripping tool 40A, the gripping unit 21, and the picking robot 10 (handling system) of this embodiment will be described.

The gripping tool 40A according to this embodiment includes the plurality of clamping claws 40 which are provided to be able to clamp the object P and extend in one direction. The clamping claw 40 includes the claw body 41 which has the planar clamping surfaces 41a for clamping the object P and intersecting the clamping direction X, the friction-holding rubber member 43 that is disposed on the side of the clamping surface 41a of the claw body 41, and the elastic body 42 which is disposed between the friction-holding rubber member 43 and the clamping surface 41a and has a lower elastic modulus than the friction-holding rubber member 43. The clamping surface 41a includes the recessed portion 45 (deformation-restrictor) which is provided on both sides of the clamping surface 41a in the width direction Y intersecting the extending direction Z of the clamping claw 40 and restricts the deformation of the elastic body 42 in the width direction Y.

In this way, when the plurality of (in this embodiment, two) clamping claws 40 clamp the object P, the elastic body 42 which is elastically deformable in the clamping direction X is elastically deformed along the shape of the held surface of the object P. At this time, the elastic body 42 can stably hold the object P due to the reaction force that tries to elastically return to the initial state. Further, the friction-holding rubber member 43 deforms (curves) in accordance with the deformation of the elastic body 42, and generates a frictional force by coming into contact with the held surface of the object P. That is, the reaction force of the elastic body 42 increases as the deformation in at least the width direction Y that follows the shape of the held surface of the object P is restrictd by the recessed portion 45 (deformation-restrictor). Therefore, the frictional force for holding the object P can be increased, and the held surface of the object P can be reliably held. In this embodiment, especially when holding an object that is difficult to be clamped, such as a vertically placed cylindrical object P, the clamping claws 40 holding the object P can stably hold the object P without shifting or falling due to the moment generated by the inertial force during horizontal movement. In this way, in this embodiment, for example, it is possible to reliably and stably hold objects P of various shapes, such as the above-described cylindrical objects P having different outer diameters.

In the gripping tool 40A of this embodiment, the claw body 41 is a rigid body. According to this configuration, since the elastic body 42 is not deformed with respect to the claw body 41, the deformation in at least the width direction Y caused when the elastic body 42 follows the shape of the held surface of the object P is more reliably restricted by the recessed portion 45 and hence the reaction force increases.

In the gripping tool 40A of this embodiment, the deformation-restrictor is the recessed portion 45 having a pair of inner wall surfaces facing each other in at least the width direction Y. The elastic body 42 is held by the pair of inner wall surfaces 451a and 451b of the recessed portion 45.

According to this configuration, when the object P is gripped by the gripping tool 40A, the elastic body 42 held inside the recessed portion 45 is elastically deformed along the shape of the held surface. In this case, the outer peripheral portion 42c of the elastic body 42 held in the recessed portion 45 is covered from the outside in the width direction Y by the pair of opposing inner wall surfaces 451a and 451b forming the recessed portion 45. Therefore, the outer peripheral portion 42c of the elastic body 42 can be protected from damage, and furthermore, the deterioration of the elastic body 42 can be suppressed, so that durability can be improved.

In the gripping tool 40A of this embodiment, the recessed portion 45 further includes the pair of inner wall surface 452 and 441 in a direction intersecting the direction in which the pair of inner wall surfaces 451a and 451b face each other. The outer peripheral surface 42c of the elastic body 42 held by the recessed portion 45 is covered from the outside in the width direction Y by the pair of facing inner wall surfaces 451a and 451b forming the recessed portion 45 and hence the deformation (in the width direction Y) is restrictd. Further, in the recessed portion 45, the second inner wall surface 452 and the third inner wall surface 441 restrict the deformation of the clamping surface 41a of the clamping portion 41B in the extending direction Z that intersects the width direction Y of the elastic body 42. According to this configuration, since the recessed portion 45 restricts the deformation in all directions along the clamping surface 41a generated according to the shape of the held surface of the object P, it is possible to more reliably maintain the deformation state that follows the shape of the held surface than when regulating only in the width direction Y. Therefore, the frictional force for holding the object P can be increased, and the held surface of the object P can be held more reliably.

In the gripping tool 40A of this embodiment, the friction-holding rubber member 43 is deformable according to the deformation of the elastic body 42. According to this configuration, since the friction-holding rubber member 43 can be curved along the elastic deformation of the elastic body 42, the reaction force (bulge) of the elastic body 42 can be brought into contact with the object P via the friction-holding rubber member 43, and hence a better gripping effect can be obtained.

In the gripping tool 40A of this embodiment, the friction-holding rubber member 43 extends longer than the elastic body 42 at the end in one direction in which the clamping claw 40 extends. According to this configuration, the friction-holding rubber member 43 is disposed on the tip side of the clamping claw 40 at a portion in which the elastic body 42 is not disposed, and the holding function can be improved by increasing the contact area of the friction-holding rubber member 43 in the holding area of the object P to be clamped.

In the gripping tool 40A of this embodiment, the width of the width direction Y and the thickness of the clamping direction X decrease as it goes toward an end (here, the tip 40b) in the direction in which the clamping claw 40 extends. According to this configuration, since the tip 40b of the clamping claw 40 has a tapered shape, the clamping claw 40 can be easily inserted into, for example, the gap between the objects P which are arranged densely. Therefore, the gripping tool 40A can reliably clamp the desired object P to be clamped.

In the gripping tool 40A of this embodiment, the width of one end (here, the tip 40b) of the clamping claw 40 is less than 20 mm. According to this configuration, for example, the clamping claws 40 can be more easily inserted into the gap between the objects P densely arranged without any interference. Therefore, in the gripping tool 40A, the clamping position for the desired object P to be clamped can be accessed with high precision.

In the gripping tool 40A of this embodiment, the tip elastic member 44 having a higher elastic modulus than the elastic body 42 is provided at the end (here, the tip 41b). According to this configuration, it is possible to elastically deform the rubber of the tip elastic member 44 and hold the object P compared to the case in which the object P is clamped between the tips made of hard metal or the like. Therefore, in the gripping tool 40A, it is possible to prevent the tip elastic member 44 from being damaged due to contact with the object P or the container in which the object P is stored. Further, since the tip elastic member 44 has elasticity, the tip elastic member can hold a small object P such as a pencil or a small block.

In the gripping tool 40A of this embodiment, the tip tapered surface 44b which decreases in thickness toward the tip is provided on the outer surface on the side opposite to the clamping surface 41a in the clamping direction X of the tip elastic member 44. According to this configuration, it is possible to perform a clamping operation so that the tip tapered surface 44b of the tip elastic member 44 follows the installation surface of the object P in a posture in which the extending direction Z of the clamping claw 40 faces is inclined from the vertical direction toward the horizontal direction. That is, since the tip tapered surface 44b is provided on the outer surface of the tip elastic member 44, for example, the tip elastic member 44 can be easily inserted between the installation surface and the lower portion of the thin part such as the edge of the object P such as a flat blister pack. Therefore, the thin part of the object P can be scooped up and held. In this way, the clamping claw 40 of this embodiment can handle the objects P placed randomly in various postures.

In the gripping tool 40A of this embodiment, an outer surface facing the outside of the clamping direction X of the claw body 41 is provided with the body-tapered surface 41g which decreases in thickness toward the tip. The body-tapered surface 41g is closely adjacent to and aligned with the tip tapered surface 44b. According to this configuration, the clamping claw 40 can be deeply inserted between the object P and the installation surface and the insertion length can be increased. Therefore, in the gripping tool 40A, the object P can be clamped in a stable posture by the clamping claw 40.

In the gripping tool 40A of this embodiment, the thickness of the elastic body 42 is larger than the thickness of the friction-holding rubber member 43. According to this configuration, when the elastically deformable thickness of the elastic body 42 is adjusted to follow the shape of the object P, the friction-holding rubber member 43 can have a friction function against the object P and can be deformed according to the elastic body 42.

In the gripping tool 40A of this embodiment, the surface of the friction-holding rubber member 43 is embossed. According to this configuration, the friction force of the friction-holding rubber member 43 against the object P can be increased and the holding force thereof can be improved. Further, in the gripping tool 40A, a friction surface can be easily formed on the friction-holding rubber member 43 by embossing.

The gripping unit 21 of this embodiment includes the gripping tool 40A and the clamping claw opening-closing portion 26 which opens and closes the plurality of clamping claws 40. According to this configuration, it is possible to provide the gripping unit 21 capable of obtaining the above-described effect.

The picking robot 10 (handling system) of this embodiment includes the gripping tool 40A and the arm 12 which is configured to be controlled by the control unit 13 and move while gripping the object P by the gripping tool 40A. According to this configuration, it is possible to provide the picking robot 10 capable of obtaining the above-described effect.

According to at least one of the above-described embodiments, the plurality of clamping claws 40 are provided to be able to clamp the object P and extend in one direction toward the tip 40b, and the clamping claw includes the claw body 41 which has a planar clamping surface clamping the object P and intersecting the clamping direction X, the elastic body 42 which is disposed on the clamping surface 41a of the claw body 41, and the friction-holding rubber member 43 which is laminated on the surface opposite to the clamping surface 41a of the elastic body 42 in the clamping direction X. The clamping surface 41a is provided with the recessed portion 45 (deformation-restrictor) which is provided on both sides of the clamping surface 41a in the width direction Y orthogonal to the extending direction Z of the clamping claw 40 and restricts the deformation of the elastic body 42 in the width direction Y. Accordingly, it is possible to realize the clamping claw 40 capable of reliably and stably clamping objects of various shapes without falling the objects.

Although several embodiments of the present invention have been described above, these embodiments are presented as examples and are not intended to limit the scope of the invention. These embodiments can be implemented in various other forms, and various omissions, substitutions, and changes can be made without departing from the gist of the invention. These embodiments and their modified examples are included within the scope and gist of the invention as well as within the scope of the invention described in the claims and its equivalents.

For example, in this embodiment, the recessed portion 45 is provided in the claw body 41 as the deformation-restrictor that restricts the elastic deformation of the elastic body 42, but the present invention is not limited to the recessed portion 45 having the pair of first inner wall surfaces 451a and 451b facing each other in at least the width direction Y. Then, regarding the configuration of the recessed portion 45, in this embodiment, the recessed portion is disposed to surround the outer peripheral surface of the elastic body 42 over the entire circumference, but the pair of inner wall surfaces 451a and 451b facing each other in at least the width direction Y are required in the recessed portion 45 in order to restrict the elastic body 42. That is, since the second inner wall surface 452 or the third inner wall surface 441 is provided to restrict the elastic body 42 from all sides, regulation can also be performed from the direction intersecting the width direction in addition to the regulation from the width direction by the first inner wall surfaces 451a and 451b. Accordingly, the total regulation effect is improved and the reaction force (bulge) of the elastic body increases. As a result, a better gripping effect can be obtained.

Further, in this embodiment, the elastic body 42 and the friction-holding rubber member 43 are arranged in both of the pair of clamping claws 40. However, it is also possible to adopt a configuration in which the elastic body 42 and the friction-holding rubber member 43 are disposed on only one of the pair of clamping claws 40 and the other claw body 41 is a rigid body.

Further, the configuration, such as the shape, size, and dimensions of each part of the clamping claw 40, the inclination angle of the tapered portion, and the joints between each member, can be changed as appropriate. For example, in this embodiment, although the elastic body 42 and the friction-holding rubber member 43 are fixed by adhesive, it is also possible to adopt a method of fixing them using fastening means such as bolts.

Further, in the above-described embodiment, an example of the robot hand 11 that combines two holding functions of clamping and suction, that is, a so-called hybrid hand method is given. Instead of this configuration, for example, the present invention may be applied to a robot hand that includes only a gripping unit.

### REFERENCE SIGNS LIST

10 Picking robot (handling system)
11 Robot hand
12 Arm
21 Gripping unit
26 Clamping claw opening-closing portion (clamping portion opening-closing portion)
40A Gripping tool
40 Clamping claw (clamping portion)
40b Tip
41 Claw body (clamping body)
41a Clamping surface
41g Body-tapered surface
42 Elastic body
43 Friction-holding rubber member (friction-holding elastic member)
44 Tip elastic member
44b Tip tapered surface
45 Recessed portion
71 Base member
451a, 451b First inner wall surface
452 Second inner wall surface
441 Third inner wall surface
P Object

What is claimed is:

1. A gripping tool comprising:
a plurality of clamping portions for clamping an object, the plurality of clamping portions extending in an extending direction,
wherein each clamping portion of the plurality of clamping portions comprises:
a clamping body having a clamping surface in planar to which a clamping direction for clamping the object crosses;
a friction-holding elastic member disposed on the clamping surface of the clamping body; and
an elastic body disposed between the friction-holding elastic member and the clamping surface, the elastic body being lower in elastic modulus than the friction-holding elastic member, and
wherein the clamping portion has a deformation-restrictor extending along opposite sides of the clamping surface, the opposite sides being separate from each other in a width direction of the clamping surface, the width direction crosses the extending direction of the clamping portion, and the deformation-restrictor being configured to restrict, in the width direction, deformation of the elastic body.

2. The gripping tool according to claim 1,
wherein the clamping body is a rigid body.

3. The gripping tool according to claim 1,
wherein the deformation-restrictor has a recessed portion, the recessed portion has a pair of inner wall surfaces facing each other in the width direction, and
wherein the elastic body is held with the pair of inner wall surfaces.

4. The gripping tool according to claim 3,
wherein the deformation-restrictor further has an additional pair of inner wall surfaces facing each other in a direction which crosses the direction in which the pair of inner wall surfaces face each other.

5. The gripping tool according to claim 1,
wherein the friction-holding elastic member is deformable, depending upon the deformation of the elastic body.

6. The gripping tool according to claim 1,
wherein the friction-holding elastic member has an end portion extending more than the elastic body in the extending direction in which the clamping portion extends.

7. The gripping tool according to claim 1,
wherein the end portion of the clamping portion is tapered and decreases in width in the width direction and in thickness.

8. The gripping tool according to claim 7,
wherein the width of the end portion of the clamping portion is less than 20 mm.

9. The gripping tool according to claim 7,
wherein the end portion has an elastic member which is greater in elastic modulus than the elastic body.

10. The gripping tool according to claim 9,
wherein the elastic member has an elastic member outer surface which faces opposite to the clamping surface, and the elastic member outer surface has an elastic-member-tapered surface with which the elastic member decreases in thickness toward an end of the clamping portion.

11. The gripping tool according to claim 10,
wherein the clamping body has a clamping body outer surface which faces outwardly in the clamping direction, the clamping body outer surface has a body-tapered surface with which the clamping body decreases in thickness toward the end of the clamping portion, and
wherein the body-tapered surface is closely adjacent to and aligned with the elastic-member-tapered surface.

12. The gripping tool according to claim 1,
wherein the elastic body is greater in thickness than the friction-holding elastic member.

13. The gripping tool according to claim 1,
wherein the friction-holding elastic member has an embossed surface.

14. A gripping unit comprising:
a gripping tool comprising:
a plurality of clamping portions for clamping an object, the plurality of
clamping portions extending in an extending direction, wherein each
clamping portion of the plurality of clamping portions comprises:
a clamping body having a clamping surface in planar to which a clamping direction for clamping the object crosses;
a friction-holding elastic member disposed on the clamping surface of the clamping body; and
an elastic body disposed between the friction-holding elastic member and the clamping surface, the elastic body being lower in elastic modulus than the friction-holding elastic member, and
wherein the clamping portion has a deformation-restrictor extending along opposite sides of the clamping surface, the opposite sides being separate from each other in a width direction of the clamping surface, the width direction crosses the extending direction of the clamping portion, and the deformation-restrictor being configured to restrict, in the width direction, deformation of the elastic body; and
a clamping portion opening-closing portion which opens and closes the plurality of clamping portions.

15. A handling system comprising:
a gripping tool comprising:
a plurality of clamping portions for clamping an object, the plurality of
clamping portions extending in an extending direction, wherein each
clamping portion of the plurality of clamping portions comprises:
a clamping body having a clamping surface in planar to which a clamping direction for clamping the object crosses;
a friction-holding elastic member disposed on the clamping surface of the clamping body; and
an elastic body disposed between the friction-holding elastic member and the clamping surface, the elastic body being lower in elastic modulus than the friction-holding elastic member, and
wherein the clamping portion has a deformation-restrictor extending along opposite sides of the clamping surface, the opposite sides being separate from each other in a width direction of the clamping surface, the width direction crosses the extending direction of the clamping portion, and the deformation-restrictor being configured to restrict, in the width direction, deformation of the elastic body; and
an arm configured to be controllable by a controller, move the object while the gripping tool griping the object.
